(19) United States
(12) Patent Application Publication
(10) Pub. No.: US 2016/0054552 A1
(43) Pub. Date: Feb. 25, 2016

(54) CONFOCAL LASER SCANNING MICROSCOPE

(71) Applicant: OLYMPUS CORPORATION, Tokyo (JP)

(72) Inventor: Yosuke TANI, Tokyo (JP)

(73) Assignee: OLYMPUS CORPORATION, Tokyo (JP)

(21) Appl. No.: 14/931,455

(22) Filed: Nov. 3, 2015

Related U.S. Application Data
(63) Continuation of application No. PCT/JP2014/060465, filed on Apr. 11, 2014.

(30) Foreign Application Priority Data
Jun. 12, 2013 (JP) 2013-124059

(51) Int. Cl. G02B 21/00

(52) U.S. Cl. CPC G02B 21/0032; G02B 21/0052

(57) ABSTRACT

A confocal laser scanning microscope includes a laser light source configured to emit laser light as illumination light, an objective, a scanner placed in an optical path between the laser light source and the objective for scanning the sample with the illumination light, and a stop placed on a pupil plane of the objective or in its vicinity, or on a plane that is optically conjugate with the pupil plane of the objective or in its vicinity, configured to block, of light from the sample, light that is a regular reflection of the illumination light cast on the sample. The stop is placed on a plane that is conjugate with the pupil plane of the objective or in its vicinity in an optical path between the laser light source and the scanner.

### CROSS-REFERENCE TO RELATED APPLICATIONS

This application is based upon and claims the benefit of priority of the prior Japanese Patent Application No. 2013-124059, filed Jun. 12, 2013, the entire contents of which are incorporated herein by reference.

This is a Continuation application of PCT Application No. PCT/JP2014/060465, filed Apr. 11, 2014, which was not published under PCT Article 21 (2) in English.

### FIELD

The present invention relates to a confocal laser scanning microscope.

### BACKGROUND

A confocal laser scanning microscope is a microscope equipped with a confocal optical system. In confocal laser scanning microscope, only the light from the focused-on portion enters the detector according to the confocal optical system, and therefore, it is possible to obtain a confocal image whose resolution, contrast and S/N ratio are higher than that of a non-confocal image obtained using a usual microscopic optical system (that is, a non-confocal optical system).

Confocal laser scanning microscope is widely used for a variety of purposes such as tests for circuit boards and observation of biological samples, and it is disclosed in Japanese Laid-open Patent Publication No. 2005-173580, for example. The confocal laser scanning microscope disclosed in Japanese Laid-open Patent Publication No. 2005-173580 is equipped with a usual microscopic optical system in addition to the confocal optical system, and it may be used with various observation methods by changing the optical element according to the observation method.

### SUMMARY

One aspect of the present embodiment provides a confocal laser scanning microscope including a laser light source configured to emit laser light as illumination light, an objective configured to cast the illumination light on a sample and to take in light from the sample, a scanner placed in an optical path between the laser light source and the objective for scanning the sample with the illumination light, and a stop placed on a pupil plane of the objective or in a vicinity of the pupil plane, or on a plane that is optically conjugate with the pupil plane of the objective or in a vicinity of the plane that is optically conjugate with the pupil plane, configured to block, of the light from the sample, light that is a regular reflection of the illumination light cast on the sample, in which the stop is placed on the plane that is optically conjugate with the pupil plane of the objective or in a vicinity of the plane that is optically conjugate with the pupil plane of the objective in an optical path between the laser light source and the scanner.

### BRIEF DESCRIPTION OF DRAWINGS

The present invention will be more apparent from the following detailed description when the accompanying drawings are referenced.

FIG. 1 illustrates an example of a confocal laser scanning microscope according to Embodiment 1 of the present invention, and the light paths of illumination light and regular reflected light;

FIG. 2 illustrates an example of a confocal laser scanning microscope according to Embodiment 1 of the present invention, and the light path of scattered light;

FIG. 3 illustrates an example of a stop of a confocal laser scanning microscope according to Embodiment 1 of the present invention;

FIG. 4 illustrates another example of a stop of a confocal laser scanning microscope according to Embodiment 1 of the present invention;

FIG. 5 illustrates an example of a stop moving mechanism that moves a stop of a confocal laser scanning microscope according to Embodiment 1 of the present invention;

FIG. 6 illustrates another example of a stop moving mechanism that moves a stop of a confocal laser scanning microscope according to Embodiment 1 of the present invention;

FIG. 7 illustrates an example of the light path of regular reflected light in a case in which the sample is tilted;

FIG. 8 illustrates an example of a confocal laser scanning microscope according to Embodiment 2 of the present invention, and the light paths of illumination light, regular reflected light and scattered light;

FIG. 9A illustrates an example of a stop of a confocal laser scanning microscope according to Embodiment 2 of the present invention, in a state before the switching of apertures;

FIG. 9B illustrates an example of a stop of a confocal laser scanning microscope according to Embodiment 2 of the present invention, in a state after the switching of apertures;

FIG. 10A illustrates an example of a stop of a confocal laser scanning microscope according to Embodiment 3 of the present invention, in a first state;

FIG. 10B illustrates an example of a stop of a confocal laser scanning microscope according to Embodiment 3 of the present invention, in a second state;

FIG. 10C illustrates an example of a stop of a confocal laser scanning microscope according to Embodiment 3 of the present invention, in a third state;

FIG. 10D illustrates an example of a stop of a confocal laser scanning microscope according to Embodiment 3 of the present invention, in a fourth state; and

FIG. 11 illustrates an example of a disk-scanning confocal laser scanning microscope.

### DESCRIPTION OF EMBODIMENTS

The confocal laser microscope disclosed in Japanese Laid-open Patent Publication No. 2005-173580 is capable of obtaining both a confocal image and a non-confocal image with bright-field observation, whereas only a non-confocal image may be obtained with dark-field observation. As mentioned earlier, generally, a confocal image has a higher resolution, contrast and S/N ratio than that of a non-confocal image, and therefore, it is desirable that a confocal image may also be obtained with dark-field observation.

### Embodiment 1

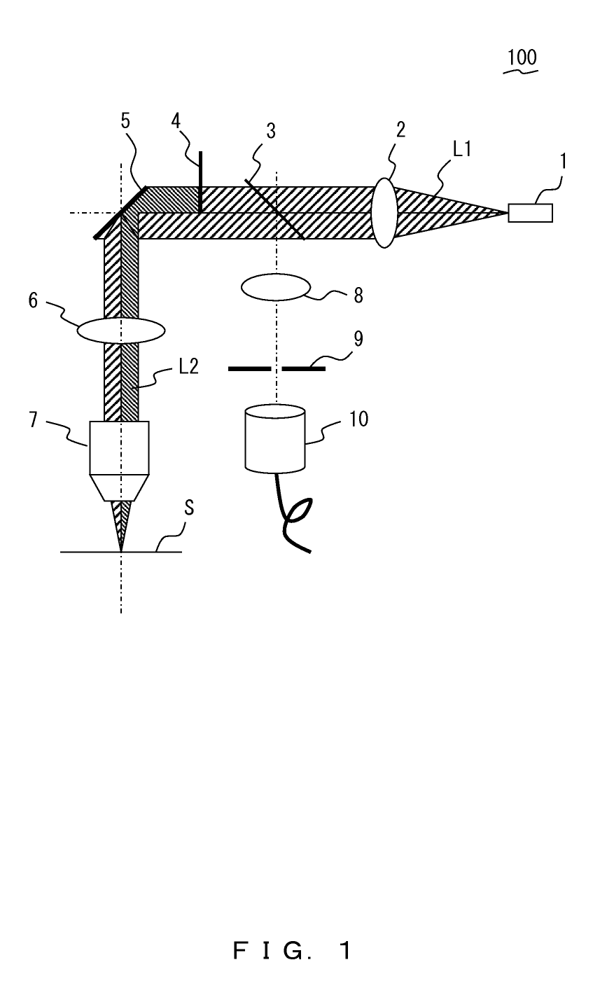

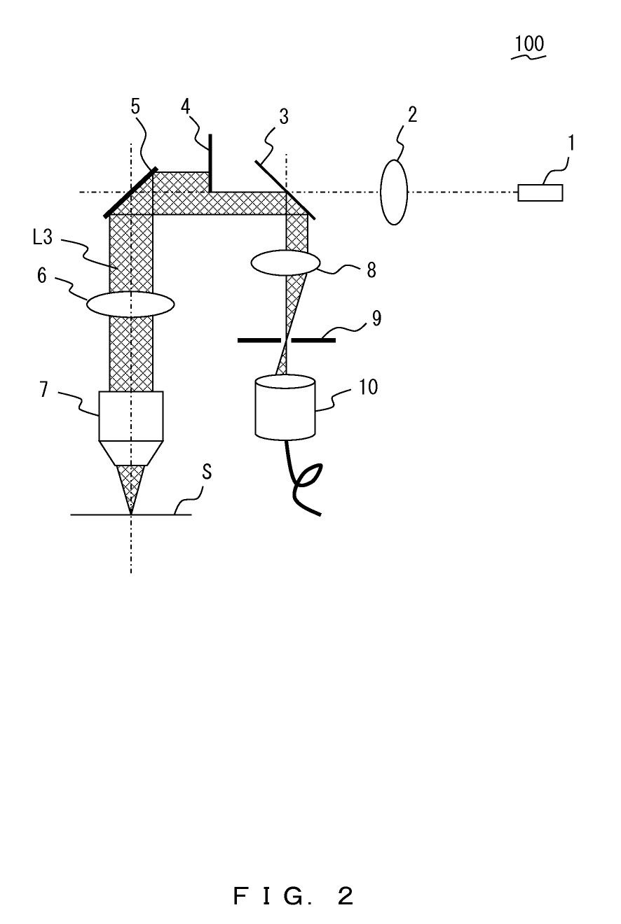

FIG. 1 and FIG. 2 illustrate a confocal laser scanning microscope 100 according to the present embodiment. Meanwhile, FIG. 1 illustrates, together with the confocal laser scanning microscope, the light path of illumination light L1 and the light path of regular reflected light L2 that represents this illumination light regularly reflected on a sample S. FIG. 2 illustrates, together with the confocal laser scanning microscope, the light path of light L3 that represents the illumination light L1 scattered or diffracted by the sample S (hereinafter, these are collectively referred to as scattered light).

The confocal laser scanning microscope 100 illustrated in FIG. 1 and FIG. 2 is a microscope in which it is possible to switch between bright-field observation and dark-field observation by inserting a stop 4 in the optical path and by removing a stop 4 from the optical path, and a confocal image may be obtained with both bright-field observation and dark-field observation.

The confocal laser scanning microscope 100 is equipped with a semiconductor laser 1, a collimating lens 2, a beam splitter 3, a stop 4, a galvano mirror 5, a pupil relay lens 6, an objective 7, a tube lens 8, a confocal pinhole plate 9, a detector 10, and a control apparatus that is not illustrated in the drawing. Meanwhile, the control apparatus is an image generating apparatus that generates a confocal image from scanning-position information about the galvano mirror 5 and the luminance signal from the detector 10.

The configuration of the confocal laser scanning microscope 100 is similar to that of a general confocal laser scanning microscope except that the confocal laser scanning microscope 100 is equipped with a stop 4. The stop 4 is placed detachably in the optical path between the semiconductor laser 1 and the galvano mirror 5; more specifically, in the optical path between the galvano mirror 5 and the beam splitter 3. In the confocal laser scanning microscope 100, dark-field observation is performed in the state in which the stop 4 is inserted in the optical path, and bright-field observation is performed in the state in which the stop 4 is removed outside the optical path.

The semiconductor laser 1 is a laser light source that emits laser light as the illumination light L1. The illumination light L1 emitted from the semiconductor laser 1 is collimated by the collimating lens 2 and enters the beam splitter 3. The beam splitter 3 is a half mirror for example, and it lets the incoming illumination light L1 pass through and enter the stop 4. The stop 4 blocks a part of the illumination light L1 that enters the stop 4 as a parallel light flux. Meanwhile, details of the stop 4 will be described later.

The illumination light L1 that passed through the stop 4 is deflected by the galvano mirror 5 placed in the optical path between the semiconductor laser 1 and the objective 7 and enters the objective 7 via the pupil relay lens 6. Then, the illumination light L1 is cast on the sample S by the objective 7.

Meanwhile, the galvano mirror 5 is placed on a plane that is optically conjugate with the pupil plane of the objective 7 or in its vicinity, and therefore, the angle of the light flux of the illumination light L1 that enters the pupil plane of the objective 7 changes along with changes in the angle of the galvano mirror 5. The light condensing position of the illumination light L1 on the sample S changes in the XY direction that is orthogonal to the optical axis of the objective 7 according to the angle of the light flux of the illumination light L1 that enters the pupil plane of the objective 7, and therefore, two-dimensional scanning of the sample S may be performed by controlling the galvano mirror 5. That is, the galvano mirror 5 is a scanner for scanning the sample S with the illumination light L1.

On the sample S irradiated with the illumination light L1, the regular reflected light L2 that is the light regularly reflected on the sample S and the scattered light L3 scattered or diffracted by a foreign object and/or a scratch on the sample S are generated. The regular reflected light L2 is illustrated in FIG. 1, and the scattered light L3 is illustrated in FIG. 2. These lights are taken in by the objective 7 and enter the stop 4 via the pupil relay lens 6 and the galvano mirror 5.

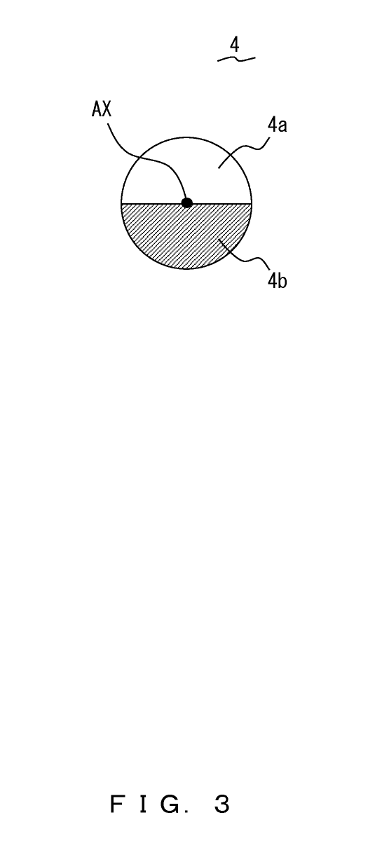

As illustrated in FIG. 3, the stop 4 is a stop in which an aperture 4a and a light blocking portion 4b are symmetrically provided with respect to the axial principal ray AX of the illumination light L1, and the stop 4 is placed on a plane that is optically conjugate with the pupil plane of the objective or in its vicinity in the optical path between the semiconductor laser 1 and the galvano mirror 5. Meanwhile, the galvano mirror 5 is also placed on a plane that is optically conjugate with the pupil plane of the objective 7 or in its vicinity, and therefore, in the present embodiment, the stop 4 is placed in the vicinity of the galvano mirror 5 on the side of the semiconductor laser 1.

On the pupil plane of the objective 7 or a plane conjugate with it, the illumination light L1 and the regular reflected light L2 enter positions that are symmetric with respect to the axial principal ray AX, respectively as a parallel light flux. Accordingly, in the stop 4 placed at the position described above, almost all of the regular reflected light L2 generated by regular reflection of the illumination light L1 that passed through the aperture 4a on the sample S enters the light blocking portion 4b, and it is blocked at the stop 4 as illustrated in FIG. 1. Therefore, the regular reflected light L2 is not detected by the detector 10.

Meanwhile, the scattered light L3 from the sample S enters both the aperture 4a and the light blocking portion 4b at the stop 4. Accordingly, the scattered light L3 that enters the light blocking portion 4b is blocked at the stop 4, but the scattered light L3 that enters the aperture 4a passes through the stop 4 as illustrated in FIG. 2. The scattered light L3 that passed through the stop 4 is reflected on the beam splitter 3, passes through the confocal pinhole formed on the confocal pinhole plate 9 via the tube lens 8, and is detected by the detector 10.

While only the light from the light condensing position of the light from the sample S has been explained above, light other than that from the light condensing position, either regular reflected light or scattered light, are blocked by the confocal pinhole plate 9. This is because the confocal pinhole is formed at a position that is optically conjugate with the focal position of the objective 7, that is, a position that is also optically conjugate with the light condensing position.

As described above, in the confocal laser scanning microscope 100, in the state in which the stop 4 is inserted in the optical path, only the scattered light L3 from the light condensing position is detected by the detector 10. Therefore, by the confocal laser scanning microscope 100 according to the present embodiment, a confocal image in dark-field observation may be obtained without using an objective for the dark field. Then, by performing dark-field observation of the sample S with the confocal image, the sample S may be observed with a higher resolution, a higher contrast, and a higher S/N ratio than that with the conventional dark-field observation.

Meanwhile, in the state in which the stop 4 is removed from the optical path, the confocal laser scanning microscope 100 is in the same configuration as that of the usual confocal laser scanning microscope, and therefore, by removing the stop 4 from the optical path, a confocal image in bright-field observation may also be obtained. Therefore, according to the confocal laser scanning microscope 100, it is possible to switch between bright-field observation and dark-field observation by just inserting and removing the stop 4 with respect to the optical path.

FIG. 1 and FIG. 2 present examples in which the stop 4 is placed on a plane that is optically conjugate with the pupil Plane of the objective 7 or in its vicinity in the optical path between the beam splitter 3 and the galvano mirror 5, but the plane on which the stop 4 is placed is not limited to this. A plane on which the illumination light L1 and the regular reflected light L2 enter positions that are approximately symmetric with respect to the optical axis will do, and therefore, the stop 4 may be placed on the pupil plane of the objective 7. That is, the stop 4 may be placed on the pupil plane of the objective 7 or in its vicinity, or a plane that is optically conjugate with the pupil plane of the objective 7 or in its vicinity. Meanwhile, when placing the stop 4 in the vicinity of the plane that is optically conjugate with the pupil plane of the objective 7, the placement is made on the side of the light source with respect to the galvano mirror 5. This is because, when the placement is made on the side of the sample S with respect to the galvano mirror 5, even when the distance from the pupil conjugate plane is small, the area that the light flux passes through changes depending on the angle of the galvano mirror 5, and accordingly, regular reflected light may not be sufficiently blocked by the light blocking portion 4b.

In addition, the arrangement of the stop 4 on the pupil plane of the objective 7 or in its vicinity, or a plane that is optically conjugate with the pupil plane of the objective 7 or in its vicinity is also desirable in that the influence of the light diffracted at the stop 4 may be limited to the minimum. Laser light is coherent light, and therefore, laser light is diffracted at the stop 4 when the stop 4 is placed in the optical path. However, in a case in which the stop 4 is placed on the pupil plane of the objective 7 or a plane that is optically conjugate with the pupil plane, even when the illumination light L1 is diffracted at the stop 4, its regular reflected light L2 does not generate, at the stop 4, the interference fringe that causes unevenness in intensity. That is, at the stop 4, symmetry is maintained for positions that the illumination light L1 and the regular reflected light 12 enter. Accordingly, the regular reflected light 12 may be blocked well without being affected by the diffraction generated at the stop 4. From such a point of view, it is also desirable to place the stop 4 on the pupil plane of the objective 7 or in its vicinity, or a plane that is optically conjugate with the pupil plane of the objective 7 or in its vicinity.

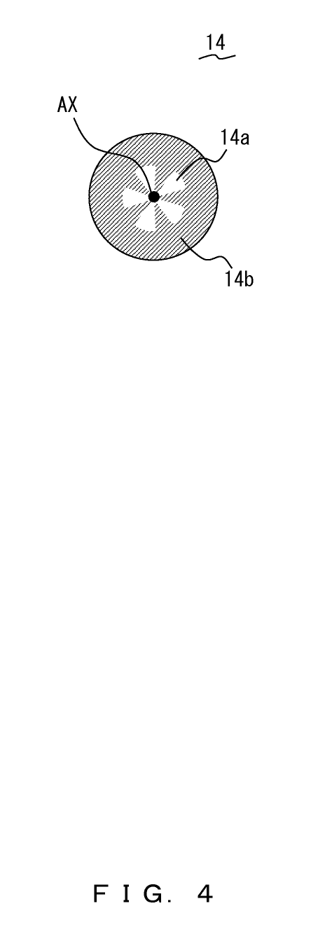

While FIG. 3 illustrates an example of the stop 4 in which the aperture 4a and the light blocking portion 4b are symmetrically provided with respect to the axial principal ray AX of the illumination light L1, the role of the stop of the confocal laser scanning microscope 100 is to block, of light from a sample S, the regular reflected light that is the illumination light cast and regularly reflected on the sample S. Therefore, as long as such a function is realized, it is not limited to the stop 4 illustrated in FIG. 3. On the pupil plane of the objective 7 or in its vicinity, or a plane that is optically conjugate with the pupil plane of the objective 7 or in its vicinity, the illumination light L1 and the regular reflected light L2 enter positions that are approximately symmetric. Accordingly, when the stop is placed on such a position, in order to block the regular reflective light, a stop in which an aperture is formed so that the area symmetric with the aperture with respect to the axial principal ray AX of the illumination light L1 becomes the light blocking portion for blocking light, and therefore, the stop may be a stop 14 illustrated in FIG. 4, for example.

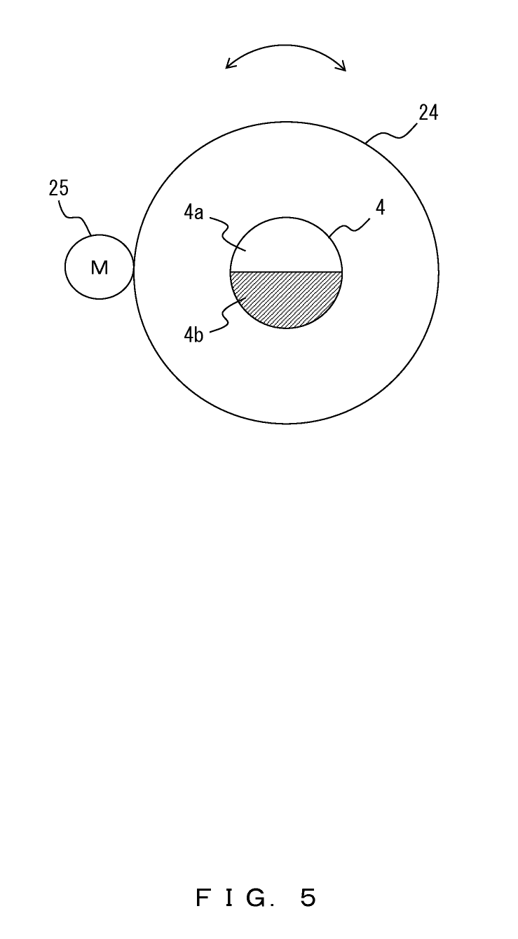

Meanwhile, the confocal laser scanning microscope 100 may further be equipped with a stop moving mechanism (a first stop moving mechanism) that moves the stop 4 so as to change the orientation of the aperture 4a with respect to the axial principal ray AX of the illumination light L1. The first stop moving mechanism is constituted by a rotary stage 24 and a driving unit 25 that drives the rotary stage 24, for example, as illustrated in FIG. 5.

The direction for illuminating the sample S (the illumination direction for the sample S) may be changed by changing the orientation of the aperture 4a by means of the first stop moving mechanism. Accordingly, in a case such as when the sample S has a scratch that is difficult to detect with a particular illumination direction, the sample S may be observed more certainly by obtaining a confocal image with a change in the illumination direction.

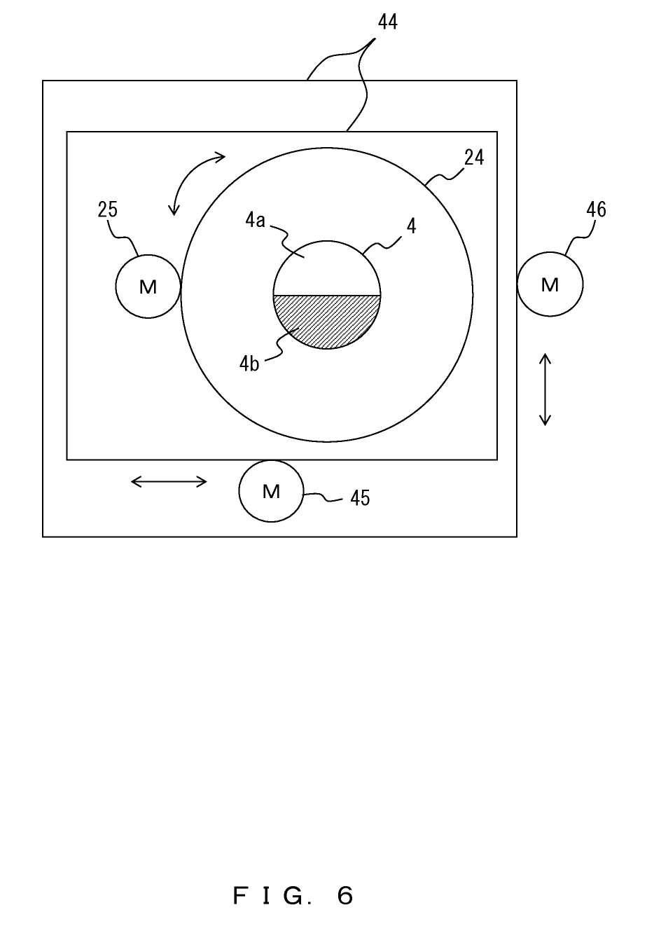

Meanwhile, in addition to the stop moving mechanism (the first stop moving mechanism) that moves the stop 4 so as to change the orientation of the aperture 4a with respect to the axial principal ray AX of the illumination light L1, the confocal laser scanning microscope 100 may be equipped with a stop moving mechanism (a second stop moving mechanism) that moves the stop 4 in the direction orthogonal to the axial principal ray AX. The second stop moving mechanism is constituted by an XY stage 44 that move in the XY direction, and a driving unit 45 and a driving unit 46 that move the XI stage 44 in the X direction and in the Y direction, respectively, and on the XY stage 44, the stop 4 and the rotary stage 24 on which the stop 4 is placed is disposed, for example, as illustrated in FIG. 6.

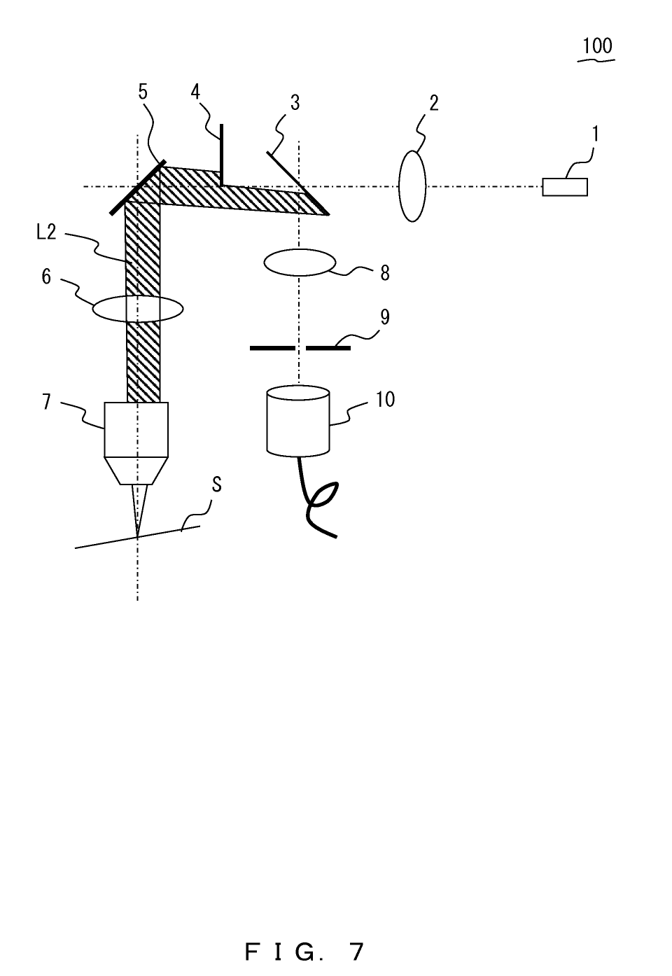

When the surface of the sample S is not orthogonal to the axial principal ray AX, that is, when the normal line of the surface of the sample S is tilted with respect to the axial principal ray AX, the regular reflected light L2 does not enter the position that is symmetric with the illumination light L1 (not illustrated in the drawing) at the stop 4, as illustrated in FIG. 7. Accordingly, in a case in which the regular reflected light L2 is shifted toward the side of the aperture compared with the case illustrated in FIG. 1, this leads to a state in which the regular reflected light L2 is not appropriately blocked, and in a case in which the regular reflected light L2 is shifted toward the side of the light blocking portion compared with the case illustrated in FIG. 1, this leads to a state in which the illumination light L1 is excessively blocked. When the confocal laser scanning microscope 100 is equipped with the second stop moving mechanism, by moving, by means of the second stop moving mechanism, the stop 4 to a position at which the regular reflected light L2 is appropriately blocked by the light blocking portion 4b and at which, also, as much of the illumination light L1 as possible passes through the aperture 4a, it becomes possible to obtain a confocal image with dark-field observation even when the surface of the sample S is not orthogonal to the axial principal ray AX. In addition, the stop 4 may also be moved to an appropriate position by both the first moving mechanism and the second moving mechanism.

### Embodiment 2

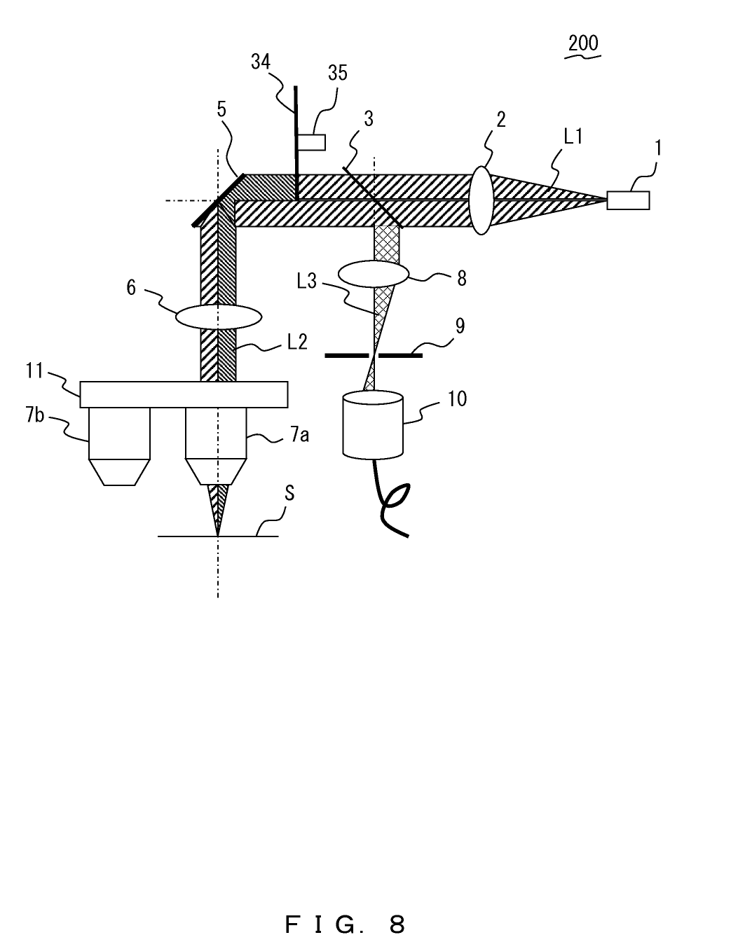

FIG. 8 illustrates an example of a confocal laser scanning microscope according to the present embodiment, and the light paths of illumination light, regular reflected light and scattered light. A confocal laser scanning microscope 200 illustrated as an example in FIG. 8 differs from the confocal laser scanning microscope 100 according to Embodiment 1 in that a stop 34 and a rotating mechanism 35 are provided instead of the stop 4, and that a plurality of objectives (an objective 7a, an objective 7b) are held by a revolver 11. Meanwhile, the stop 34 is placed on a plane similar to that for the stop 4.

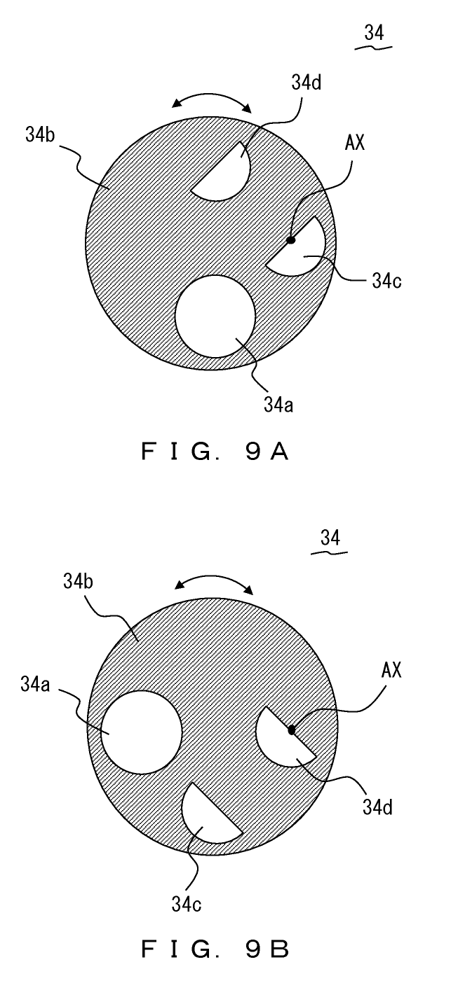

As illustrated in FIG. 9A and FIG. 9B, the stop 34 is a stop in which a plurality of apertures (an aperture 34a, an aperture 34c, an aperture 34d) are formed. The rotating mechanism 35 is a stop moving mechanism (the first stop moving mechanism) that moves the stop 34 so that an aperture selected from the plurality of apertures is placed in the optical path between the semiconductor laser 1 and the galvano mirror 5. The plurality of apertures formed in the stop 34 are switched and placed in the optical path between the semiconductor laser 1 and the galvano mirror 5 by means of the rotation of the stop 34 along with the rotation of the rotating mechanism 35.

The aperture 34a is an aperture for bright-field observation that has a diameter larger than the diameter of the light flux of the illumination light L1 (more specifically, the diameter of the pupil image of the objective projected onto the pupil conjugate plane). Each of the aperture 34c and the aperture 34d is an aperture for dark-field observation formed so that, when placed in the optical path, the symmetric area with the aperture with respect to the axial principal ray AX of the illumination light L1 becomes the light blocking portion 34b that blocks light.

FIG. 9A illustrates a state in which the aperture 34c is placed in the optical path, and FIG. 9B illustrates a state in which the stop 34 has rotated clockwise from the state in FIG. 9A and the aperture 34d is placed in the optical path. As illustrated in FIG. 9A and FIG. 9B, the aperture 34c and the aperture 34d are formed so that their orientations with respect to the axial principal ray AX of the illumination light L1 differ by 90 degrees when placed in the optical path.

According to the confocal laser scanning microscope 200 according to the present embodiment configured as described above, a confocal image in dark-field observation may be obtained without using an objective for the dark field in a similar manner as the confocal laser scanning microscope 100 according to Embodiment 1, by placing the aperture 34c or the aperture 34d in the optical path.

In addition, in the confocal laser scanning microscope 200, a confocal image in bright-field observation may be obtained by placing the aperture 34a on the optical path. Therefore, it is possible to switch between bright-field observation and dark-field observation by just rotating the stop 34 by means of the rotating mechanism 35, without removing the stop 34.

Furthermore, in the confocal laser scanning microscope 200, it is possible to change the orientation of the aperture by switching the aperture to be placed in the optical path by rotating the stop 34 by means of the rotating mechanism 35. Accordingly, in a similar manner to the confocal laser scanning microscope 100 according to Embodiment 1, in a case such as when the sample S has a scratch that is difficult to detect with a particular illumination direction, the sample S may be observed more certainly by obtaining a confocal image with a change in the illumination direction.

In the confocal laser scanning microscope 200, the objective to be placed in the optical path may be switched by rotating the revolver 11. The position of the optical axis of each of the objectives placed in the optical path may be slightly different due to manufacturing errors in the objectives and/or the revolver 11, and as a result, the regular reflected light L2 may not be appropriately blocked by the light blocking portion 34b in some cases. In such a case, a fine adjustment of the position of the aperture may be performed by rotating the stop 34 by means of the rotating mechanism 35 so that the regular reflected light L2 may be appropriately blocked. Accordingly, a confocal image with a high contrast may be obtained by dark-field observation, regardless of the objective.

In addition, in a similar manner to the confocal laser scanning microscope 100 according to Embodiment 1, the confocal laser scanning microscope 200 may also be equipped with a second stop moving mechanism that moves the stop 34 in the direction orthogonal to the axial principal ray AX, in addition to the first stop moving mechanism.

### Embodiment 3

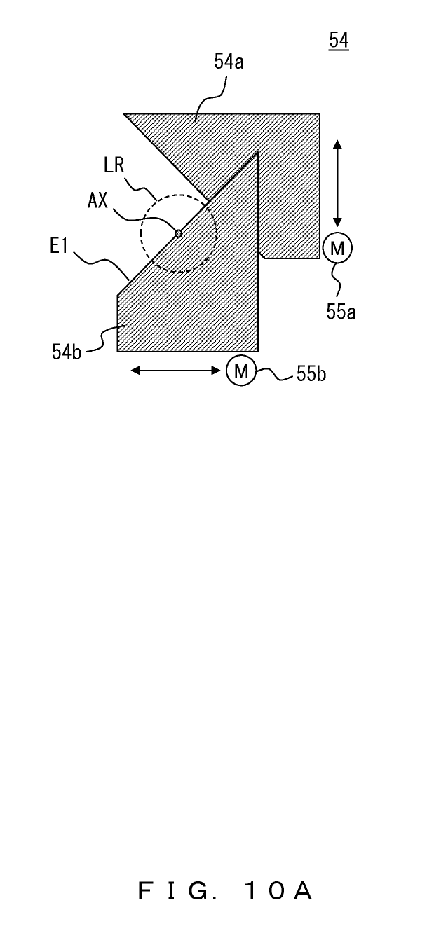

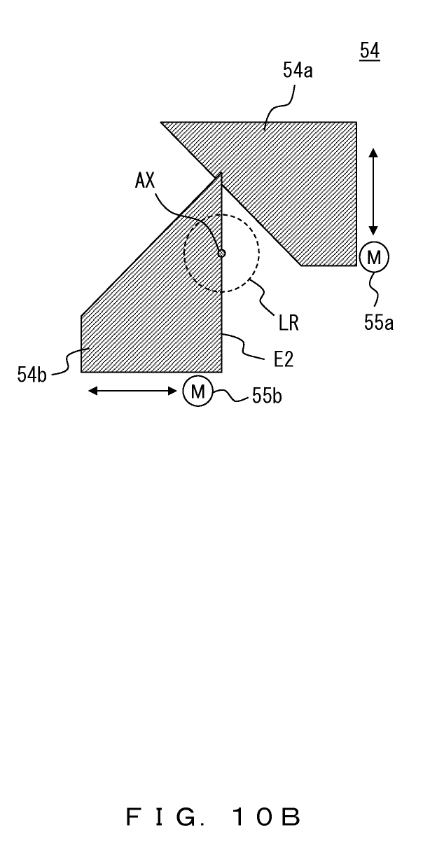

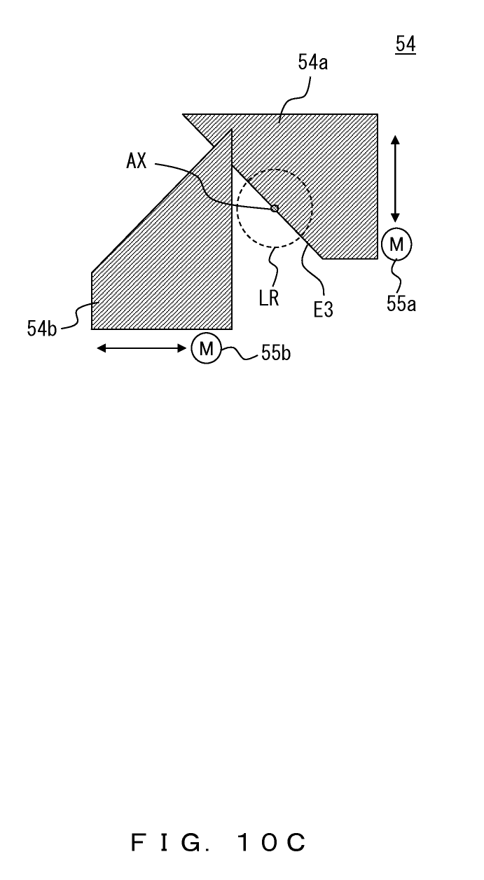

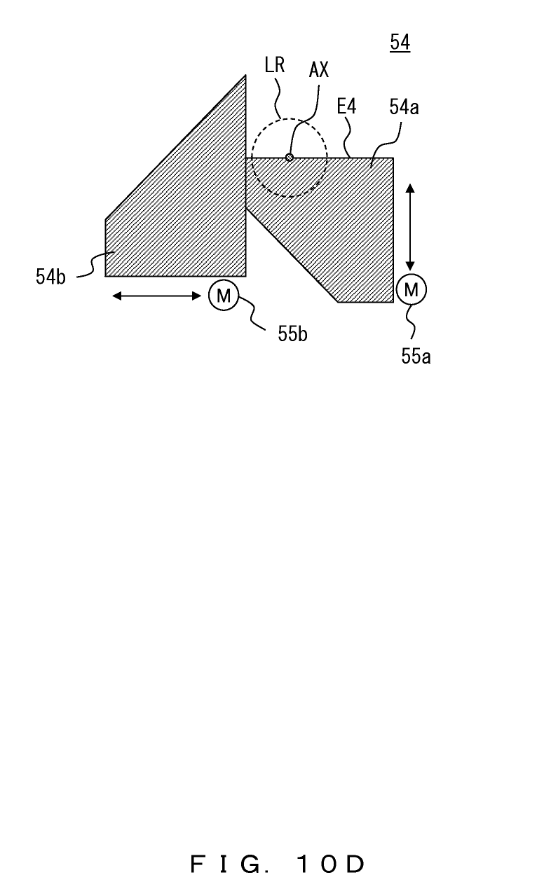

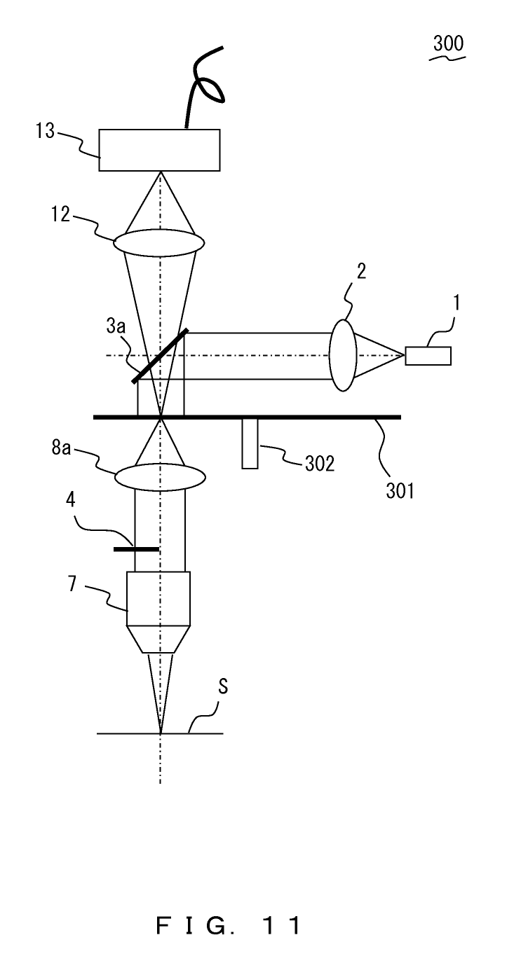

A confocal laser scanning microscope according to the present embodiment differs from the confocal laser scanning microscope 100 according to Embodiment 1 in that a stop 54 illustrated in FIG. 10A through FIG. 10D are provided instead of the stop 4. Meanwhile, the stop 54 is placed on a plane similar to that for the stop 4.

The stop 54 includes a plurality of light blocking plates (a light blocking plate 54a, a light blocking plate 54b) provided so that they may be moved by means of a light blocking plate moving mechanism (a driving unit 55a, a driving unit 55b) in directions different from each other (X direction, Y direction) that are orthogonal to the axial principal ray AX of the illumination light L1.

The driving unit 55a and the driving unit 55b move the light blocking plate 54a and the light blocking plate 54b so that the area that is symmetric with the aperture of the stop 54 with respect to the axial principal ray AX of the illumination light L1 becomes the blocking portion that blocks light. Accordingly, the regular reflected light L2 is blocked by the light blocking plate 54a or the light blocking plate 54b. Therefore, according to the confocal laser scanning microscope according to the present embodiment, a confocal image in dark-field observation may also be obtained without using an objective for the dark field, in a similar manner to the confocal laser scanning microscope 100 according to Embodiment 1.

In addition, it is also possible to obtain a confocal image in bright-field observation by moving the light blocking plate 54a and the light blocking plate 54b by means of the driving unit 55a and the driving unit 55b to positions that are outside of the area LR that the light flux of the illumination light L1 passes through. Therefore, in the confocal laser scanning microscope, it is possible to switch between bright-field observation and dark-field observation by just moving the light blocking plate 54a and the light blocking plate 54b by means of the driving unit 55a and the driving unit 55b, without removing the whole of the stop 54.

Meanwhile, the light blocking plate 54a and the light blocking plate 54b have four sides (E1, E2, E3, E4) with angles that differ by 45 degrees. Accordingly, by selectively placing these four sides on the axial principal ray AX, the illumination direction may be changed by 45 degrees. Therefore, by the confocal laser scanning microscope according to the present embodiment, in a similar manner to the confocal laser scanning microscope 100 according to Embodiment 1, in a case such as when the sample S has a scratch that is difficult to detect with a particular illumination direction, the sample S may be observed more certainly by obtaining a confocal image with a change in the illumination direction. Meanwhile, FIG. 10A through FIG. 10D illustrate arrangements of the stop 54 that realize illumination directions that differ from each other by 45 degrees.

Furthermore, the shape of the aperture of the stop 54 may be arbitrarily changed by adjusting the arrangements of the light blocking plate 54a and the light blocking plate 54b. On the pupil plane of the objective 7 or the plane that is optically conjugate with the pupil plane, the larger the distance from the optical axis, the greater the numerical aperture of the light that passes through. Accordingly, by adjusting the shape of the aperture of the stop 54, it becomes possible to detect only scattered light that has a numerical aperture in a particular range. Therefore, in the confocal laser scanning microscope, in consideration of the fact that the intensity and scattering angle of light scattered by a foreign object on the sample S depend on the size of the foreign object, a foreign object of a particular size may be detected with a high sensitivity by adjusting the aperture shape.

In addition, in the confocal laser scanning microscope according to the present embodiment, the positions of the light blocking plate 54a and the light blocking plate 54b may be adjusted according to the optical axis position of the objective that changes along with the switching of the objectives. Accordingly, in a similar manner to the confocal laser scanning microscope 200 according to Embodiment 2, a confocal image with a high contrast may be obtained by dark-field observation, regardless of the objective.

The embodiments described above are illustrations of specific examples provided in order to facilitate understanding of the invention, and the present invention is not limited to these embodiments. The confocal laser scanning microscope may be modified and changed in various ways without departing from the idea of the present invention defined by the scope of the claims.

For example, while the confocal laser scanning microscopes presented in Embodiment 1 through Embodiment 3 are all point-scanning-type microscopes, the confocal laser scanning microscope may be modified to a disk-scanning-type confocal laser scanning microscope 300 such as the one illustrated in FIG. 11. According to the disk-scanning-type confocal laser scanning microscope 300, a confocal image in dark-field observation may also be obtained, by placing the stop presented in the embodiments described above on the pupil plane of the objective 7 or in its vicinity, or on a plane that is optically conjugate with the pupil plane of the objective 7 or in its vicinity.

Meanwhile, the confocal laser scanning microscope 300 illustrated in FIG. 11 has a configuration similar to that of a general disk-scanning-type confocal laser scanning microscope, except that the stop 4 is included. A rotating disk 301 is, for example, a Nipkow disk that is rotated by means of a rotating mechanism 302, and it is placed on a plane that is optically conjugate with the focal plane of the objective 7 and a CCD camera 13. The conjugate relationship between the focal plane of the objective 7 and the rotating disk 301 is formed by the objective 7 and a tube lens 8a, and the conjugate relationship between the rotating disk 301 and the CCD camera 13 is formed by a condenser lens 12. The beam splitter 3a is a half mirror, for example.

What is claimed is:

1. A confocal laser scanning microscope comprising:
a laser light source configured to emit laser light as illumination light;
an objective configured to cast the illumination light on a sample and to take in light from the sample;
a scanner placed in an optical path between the laser light source and the objective for scanning the sample with the illumination light; and
a stop placed on a pupil plane of the objective or in a vicinity of the pupil plane, or on a plane that is optically conjugate with the pupil plane of the objective or in a vicinity of the plane that is optically conjugate with the pupil plane, configured to block, of the light from the sample, light that is a regular reflection of the illumination light cast on the sample,
wherein
the stop is placed on a plane that is conjugate with the pupil plane of the objective or in a vicinity of the plane that is optically conjugate with the pupil plane in an optical path between the laser light source and the scanner.

2. The confocal laser scanning microscope according to claim 1, wherein
the stop is a stop in which an aperture is formed so that an area that is symmetric with the aperture with respect to an axial principal ray of the illumination light becomes a light blocking portion that blocks light.

3. The confocal laser scanning microscope according to claim 2, further comprising
a first stop moving mechanism configured to move the stop so as to change an orientation of the aperture with respect to the axial principal ray of the illumination light.

4. The confocal laser scanning microscope according to claim 1, wherein:
the stop is a stop in which a plurality of apertures that are switched and placed in the optical path between the laser light source and the scanner by a movement of the stop are formed, and
each of the plurality of apertures is formed so that, when each of the plurality of apertures is placed in the optical path, an area that is symmetric with the aperture with respect to an axial principal ray of the illumination light becomes a light blocking portion that blocks light.

5. The confocal laser scanning microscope according to claim 4, wherein
orientations of the plurality of the apertures with respect to the axial principal ray of the illumination light are different from each other, when placed in the optical path.

6. The confocal laser scanning microscope according to claim 4, further comprising
a first stop moving mechanism configured to move the stop so that an aperture selected from the plurality of apertures is placed in the optical path between the laser light source and the scanner.

7. The confocal laser scanning microscope according to claim 1, further comprising
a second stop moving unit configured to move the stop in a direction orthogonal to an axial principal ray of the illumination light.

8. The confocal laser scanning microscope according to claim 1, wherein:
the stop includes a plurality of light blocking plates provided so as to move in different directions that are orthogonal to an axial principal ray of the illumination light, and
the confocal laser scanning microscope further comprises a light blocking plate moving mechanism configured to move the plurality of light blocking plates so that an area that is symmetric with the aperture of the stop with respect to the axial principal ray of the illumination light becomes a blocking portion that blocks light.

9. The confocal laser scanning microscope according to claim 1, wherein
the stop is placed detachably with respect to the optical path between the laser light source and the scanner.
